(19) United States
(12) Patent Application Publication
(10) Pub. No.: US 2003/0154581 A1
(43) Pub. Date: Aug. 21, 2003

(54) Personalized sculpture as a cremation urn

(76) Inventors: Prabhat Jain, New Orleans, LA (US); Joel Lema, Kenner, LA (US); Kenneth W. Bickford, New Orleans, LA (US)

Correspondence Address: PRABHAT JAIN, 4219 BARONNE, NEW ORLEANS, LA, 70115, US

(21) Appl. No.: 10/280,797

(22) Filed: Oct. 25, 2002

Related U.S. Application Data
(60) Provisional application No. 60/336,241, filed on Oct. 25, 2001.

(51) Int. Cl. A61G 17/00

(52) U.S. Cl. 27/1

(57) ABSTRACT

A novel system and method for the containment of cremated remains using a personalized sculpture made in the likeness of a decedent thereby fulfilling the function of a cremation Urn.

The system contemplates a unique memorialization of the cremated remains as a three dimensional sculpture in the likeness of the decedent (“Sculpture”), by blending the cremated remains into the Sculpture, during the sculpture creation process, or by providing a vessel, either molded in the Sculpture or attached to the Sculpture, for permanent containment of cremated remains.

The preferred embodiment of the present system includes the steps of blending all, or a portion of the cremated remains with casting materials to create a three dimensional sculpture in the likeness of the decedent. Then finishing and adorning the Sculpture to produce a sculpture which is pleasing to view as well as providing a fitting remembrance to the decedent.

### REFERENCE TO RELATED APPLICATIONS

This application claims the benefits of U.S. provisional application number 60/336,241 filed on Oct. 25, 2001, entitled “Personalized Sculpture as a Cremation Urn”

### BACKGROUND

The invention relates to a process in which cremated remains of a decedent can be utilized in a personalized sculpture made in the likeness of a decedent. This sculpture can function as a cremation Urn. Currently cremated remains have been utilized in certain art forms such as paintings. However, no processes exist today in which personal sculptures in the likeness of the decedent have been utilized as cremation Urn(s)

### SUMMARY

A novel system and method for the containment of cremated remains using a personalized sculpture made in the likeness of a decedent thereby fulfilling the function of a cremation Urn.

The system contemplates a unique memorialization of the cremated remains as a three dimensional sculpture in the likeness of the decedent (“Sculpture”), by blending the cremated remains into the Sculpture, during the sculpture creation process, or by providing a vessel, either molded in the Sculpture or attached to the Sculpture, for permanent containment of cremated remains.

The preferred embodiment of the present system includes the steps of blending all, or a portion of the cremated remains with casting materials to create a three dimensional sculpture in the likeness of the decedent. Then finishing and adorning the Sculpture to produce a sculpture which is pleasing to view as well as providing a fitting remembrance to the decedent.

### DETAILED DESCRIPTION

The system starts by acquiring the master pattern of the decedent (human or animal). In the preferred embodiment, this master pattern is created using three-dimensional scanning of the decedent and rapid prototype machines to manufacture the master pattern. This method is described in U.S. patent application Ser. No. 09/879601, file date of Jun. 22, 2000, which is incorporated by reference. The master pattern can also be created using an equivalent method comprising the use of a sculptor to fashion the master pattern as a Sculpture from drawing, sketches, and photographs. The master pattern can be fashioned to include a cavity to serve as a containment vessel for cremation remains. The master pattern can also be fashioned to include a separate containment vessel for cremation remains. Once the master pattern is created then a mold is fashioned from the master pattern. The molding material can be selected from the group consisting of silicone rubber, plastics, plaster, and any other molding materials. Once the molding is completed then the casting steps are started. In the preferred embodiment, a process commonly known as cold casting is used. The casting material comprises a portion of the cremated remains of a decedent blended with a resin and bronze powder. The Sculpture is cast from the master mold by pouring several layers of casting material into the mold. The initial casting mixture is comprised of 80% bronze powder by weight, 15% resin by weight, and 5% cremated remains by weight. Subsequent mixtures may be comprised of increasing cremation remains by weight with a corresponding decrease in the metal powder by weight. The former mixture ratios may be varied according to external requirements, such as total weight, finish or any other external requirement. Other equivalent methods used to create the Sculpture from the master pattern mold may comprise using hot molten metals blended with cremated remains, as the casting material. Plaster and any naturally occurring or synthetically derived powder mixture, blended with a portion of the cremated remains can also comprise an equivalent casting material. Glass, frosted glass, and any glass like derivatives blended with cremated remains may also comprise an equivalent casting material. Acrylics and other man made synthetics combined with cremated remains may also comprise an equivalent casting material. Once the Sculpture is cast then the Sculpture is prepared and adorned in a fashion that is fitting for remembrance of the decedent. The Sculpture may then undergo a refinishing process that may comprise embellishing, burnishing, adding lettering, adding plaques with lettering, or any other adornment. A sculptor, artisan, laborer, machine, or any other refinishing method may do the refinishing. If the Sculpture has a cavity for cremated remains, then the cavity may be filled with a separate containment vessel.

What is claimed is:

1. A method for creating a cremation urn utilizing the cremated remains blended into the casting materials used to create personalized sculptures in the likeness of the decedent comprising:
a) Creating a master pattern in the likeness of the decedent
b) Using the master pattern to create a mold
c) Blending all, or a portion of, the cremation remains with the casting material.
d) Creating the personalized sculpture by casting the sculpture using the above mentioned mold and the above mentioned casting material

2. A method as in claim 1, wherein (a) the master pattern is created using the method described in U.S. patent application Ser. No. 09/879601, file date Jun. 22, 2000, which is incorporated by reference

3. A method as in claim 1, wherein (c) the casting material comprises the cremation remains and a molten metal selected from the group consisting of bronze, copper, gold, platinum, and any other type of metal or alloy.

4. A method as in claim 1, wherein (c) the casting material comprises the cremation remains and a resin and metal powder mixture selected from the group consisting of cold cast bronze, and any other type of metal resin mixture.

5. A method as in claim 1, wherein (c) the casting material comprises the cremation remains and a naturally occurring or synthetically derived powder mixture selected from the group consisting of plaster, cement, concrete, clay, and any other naturally occurring or synthetically derived powder mixture.

6. A method as in claim 1, wherein (c) the casting material comprises the cremation remains and a glass based mixture selected from the group consisting of glass, frosted glass, and any other glass based mixture.

7. A method as in claim 1, wherein (c) the casting material comprises the cremation remains and a mixture selected from the group consisting of acrylics, and any other man made synthetics.

8. A cremation urn comprising a sculpture in the likeness of a decedent and all or portion of, the cremation remains of the decedent

9. A cremation urn comprising a sculpture in the likeness of a decedent wherein the sculpture includes a cremation containment vessel for holding the cremation remains of the decedent

10. A method for creating a cremation urn by providing a vessel for permanent containment of the cremated remains of the decedent within a personalized sculpture in the likeness of a decedent comprising:
a) Creating a master pattern in the likeness of the decedent.
b) Using the master pattern to create a mold
c) Fashioning a cremation containment vessel and inserting the vessel into the master mold
d) Creating the personalized sculpture in the likeness of a decedent by casting the sculpture using the above mentioned master mold and casting material.

11. A method as in claim 2, wherein (d) the containment vessel is not inserted into the master mold and wherein (e) the containment vessel is attached to the sculpture.
